(19) United States
(12) Patent Application Publication
(10) Pub. No.: US 2008/0020232 A1
(43) Pub. Date: Jan. 24, 2008

(54) Solar Control Polymer Films Comprising an Aluminum Oxide Coating

(76) Inventors: Lisa Yvonne Winckler, Collinsville, VA (US); Charles Nicholas Van Nutt, Martinsville, VA (US); Janos Czukor, Martinsville, VA (US)

Correspondence Address: BRENC LAW;ANDREW BRENC, P.O. BOX 155, ALBION, PA, 16401-0155, US

(21) Appl. No.: 11/780,415

(22) Filed: Jul. 19, 2007

Related U.S. Application Data
(60) Provisional application No. 60/826,244, filed on Sep. 20, 2006.
(60) Provisional application No. 60/807,866, filed on Jul. 20, 2006.

(51) Int. Cl. B32B 17/10; B32B 15/08

(52) U.S. Cl. 428/626; 428/336; 428/457; 523/135

(57) ABSTRACT

Now, according to the present invention, performance solar control films are provided that are effective at reducing the transmission of solar radiation without also detrimentally affecting the transmission of radio waves or other wavelengths that are used for communication, such as for satellite communication or cell phones. Solar control films of the present invention comprise a polymer film onto which a layer of non-stoichiometric aluminum oxide has been formed.

### CROSS-REFERENCE TO RELATED APPLICATIONS

This application claims priority to U.S. Provisional Applications 60/826,244, filed on Sep. 20, 2006, and 60/807,866, filed on Jul. 20, 2006, each of which is hereby incorporated by reference in its entirety.

### FIELD OF THE INVENTION

The present invention is in the field of solar control films, and, specifically, the present invention is in the field of solar control films that are used in vehicle and architectural applications to reduce heat buildup in an enclosed space.

### BACKGROUND

Polymeric, transparent performance films that can be disposed directly on the surface of glass have been used to reduce the amount of electromagnetic radiation of various wavelengths passing through the glass. Performance films typically comprise a polymer film substrate onto which one or more layers of metals and/or dielectric materials have been applied. The applied layers function to absorb and/or reflect a subset of wavelengths of electromagnetic radiation, where the wavelength is determined by the thicknesses and optical properties of the applied layers.

One broad application of this technology involves using a coated film to reduce the amount of solar radiation that passes through an opening into an enclosed space. In a typical embodiment, these solar control films are applied to the window of an automobile or other vehicle in order to reduce the amount of solar radiation that enters the vehicle. Performance films of this type are designed, or “tuned”, to absorb and/or reflect an acceptably low percentage of the visible solar spectrum while still preventing the transmission of enough total solar radiation to appreciably reduce the heat gain inside a vehicle caused by exposure to solar radiation.

Conventional solar control films, however, often attenuate or bypass electromagnetic radiation that is well outside of the solar spectrum in addition to the targeted wavelengths within the solar spectrum. Conventional solar control films that are effective at attenuating solar radiation, for example, because of the nature of the applied metal layer, are also effective at attenuating radiation in the radio wave region of the electromagnetic spectrum. This collateral blocking is unacceptable in many applications, such as, for example, in applications in which an automobile radio antenna is formed on the interior surface of a glass rear window. Application of a conventional solar control film to a rear window comprising such an antenna can result in a reduction of radio wave transmission that is significant enough to prevent normal radio function within the vehicle.

There is therefore a need in the art for performance films that provide the desired solar control without a concomitant reduction in transmission of radio waves.

### SUMMARY OF THE INVENTION

Now, according to the present invention, performance solar control films are provided that are effective at reducing the transmission of solar radiation without also detrimentally affecting the transmission of radio waves or other wavelengths that are used for communication, such as for satellite communication or cell phones. Solar control films of the present invention comprise a polymer film onto which a layer of non-stoichiometric aluminum oxide has been formed.

### DETAILED DESCRIPTION

Solar control films of the present invention comprise a polymer film substrate layer onto which a layer of non-stoichiometric aluminum oxide is deposited. As will be described in detail below, the polymer film substrate can comprise any suitable polymeric substrate, and, in a preferred embodiment, the polymer film comprises poly(ethylene terephthalate).

Polymer films of the present invention are formed by depositing aluminum oxide on a polymer film in a manner that results in a non-stoichiometric layer of aluminum oxide. As used herein, “non-stoichiometric” aluminum oxide means aluminum oxide in which the atomic ratio of oxygen to aluminum is less than 3 to 2. Fully oxidized aluminum is commonly known as Al₂O₃. Aluminum metal, by nature, when exposed to the atmosphere, gets covered with a “native” oxide layer. This native oxide layer is fully oxidized and prevents the further oxidization of the rest of the metal underneath when it has reached to about three nanometers thickness. For the purposes of the present invention, the term “non-stoichiometric” aluminum oxide refers only to the aluminum oxide under the native oxide layer, and so a “layer of non-stoichiometric aluminum oxide” comprises, in addition to an underlying non-stoichiometric portion, a very thin, overlying portion that is fully oxidized aluminum oxide. Ratios of oxygen and aluminum provided herein for “non-stoichiometric” aluminum oxide refer only to the underlying portion of non-stoichiometric aluminum oxide, and not to the very thin native oxide layer that becomes oxidized during or immediately after fabrication of the aluminum oxide layer.

In further embodiments of the present invention, the atomic ratio of oxygen to aluminum in non-stoichiometric aluminum oxide of the present invention is less than 2.55 to 2, less than 3 to 4, or less than 1 to 2. For any of these embodiments, as well as the embodiments with an atomic ratio of less than 3 to 2, the lower limit of the atomic ratio can be greater than 1 to 50.

The non-stoichiometric aluminum oxide layer can be formed in any suitable thickness, and, in preferred embodiments, the layer has a thickness of 3.5 to 50 nanometers, 3.5 to 40 nanometers, or 3.5 to 30 nanometers.

The non-stoichiometric aluminum oxide layer, in various embodiments, has the following light transmission characteristics: solar transmission 2 to 90%, visible light transmission 2 to 90%, ultraviolet transmission 2 to 90%, and infrared transmission of 2 to 90%. In other embodiments, the non-stoichiometric aluminum oxide layer has the following light transmission characteristics: solar transmission 45 to 55%, visible light transmission 45 to 55%, ultraviolet transmission 25 to 45%, and infrared transmission 55 to 85%.

The non-stoichiometric aluminum oxide layer, in various embodiments, has the following transmission characteristics for the given frequencies of the electromagnetic spectrum: 0.5 to 1.6 MHz—less than 1 dB attenuation; 88 to 108 MH—less than 1 dB or less than 0.1 dB attenuation; 824 to 849 MHz—less than 1 dB or less than 0.1 dB attenuation; and, 1,400 to 1,600—less than 1 dB or less than 0.1 dB attenuation.

Non-stoichiometric aluminum oxide layers of the present invention have a surface resistivity (ρ), measured as ohms per square, of at least 1,000, and, in various embodiments, greater than 1,500, 2,500, or 4,000 ohms per square. The surface resistivity of the non-stoichiometric aluminum oxide layer has been found to be an important factor in transmission of the various wavelengths of interest, with layers having lower surface resistivity showing progressively worse transmission characteristics.

Formation of a non-stoichiometric layer of aluminum oxide can be accomplished using conventional vacuum deposition techniques such as sputtering or evaporation of aluminum in an atmosphere that comprises an oxidizing gas and, optionally, an inert gas, such as argon. By controlling the amount of oxygen in the vacuum deposition atmosphere, the aluminum to oxygen ratio can be adjusted to produce the desired non-stoichiometric aluminum oxide layer.

In other embodiments, non-stoichiometric aluminum oxide can be provided as the target in a sputtering process or as the evaporative material in an evaporation process in a atmosphere substantially lacking an oxidizing gas. In these processes, the final oxygen to aluminum ratio of the non-stoichiometric layer of aluminum oxide will be determined by the ratio found in the starting material.

As an alternative to vacuum deposition, a nano particulate solution or suspension of aluminum oxide can be prepared and spread on a film layer to form the non-stoichiometric aluminum oxide layer.

In addition to aluminum oxide, other non-stoichiometric combinations can be employed. In various embodiments, in place of aluminum, any of the following elements can be used: chrome, niobium, tantalum, zirconium cobalt, silicon, copper, osmium, tungsten, and titanium. In various embodiments, nitrogen or its compounds can be used in place of or in addition to oxygen to result in non-stoichiometric metal nitrides and oxinitrides.

In various embodiments of the present invention, a polymer film includes a porous primer layer, such as a silicon oxide layer, onto which other layers can be deposited. Porous primer layers include those described in issued U.S. Pat. No. 6,123,986.

In various embodiments of the present invention, a layer of nickel or nickel alloy is included between the polymer film and the layer of non-stoichiometric aluminum oxide. A porous primer layer can be included on the polymer film. The nickel or nickel alloy layer can be applied using any suitable means, such as sputtering, and can be any suitable thickness. In preferred embodiments, the nickel or nickel alloy layer is 0.50 to 5.0 nanometers, 1.0 to 3.0 nanometers, or 1.50 to 2.35 nanometers. In a preferred embodiment, a nickel alloy is used having the following composition, with each element given as a maximum percent by weight: C 0.004, Fe 5.31, Mo 15.42, Mn 0.48, Co 1.70, Cr 15.40, Si 0.02, S 0.004, P 0.005, W 3.39, V 0.16, and the balance as Ni.

In various embodiments, other suitable metals other than nickel and nickel alloys can be employed as described in the preceding paragraph. In various embodiments, Al, Ti, Ag, Au, Cu, Sn, Zn, Ni, and the like, and/or their alloys are used. In various embodiments, aluminum or titanium is used.

Polymer films of the present invention that comprise a layer of non-stoichiometric aluminum oxide can be adhered to any suitable glazing substrate using any suitable adhesive. In various embodiments of the present invention, a polymer film is adhered to a window or windshield of a vehicle. In other embodiments, a polymer film is adhered to architectural glass, such as a window. In either case, a glass composite is formed that comprises glass or a glass laminate and a polymer film of the present invention comprising a layer of non-stoichiometric aluminum oxide. For these applications, adhesives such as a pressure sensitive adhesive, for example silicone or acrylic, that is a removable adhesive or a permanent adhesive, can be formed to completely cover the polymer film or only a sub-portion thereof. Adhesives can be applied to the polymer film, or they can be sprayed on or otherwise applied to the glass onto which the polymer film is applied. Applications such as these can be retrofit applications or new glass applications.

In various embodiments, solar control glass (solar glass) is used as a glass layer of the present invention. Solar glass can be any conventional glass that incorporates one or more additives to improve the optical qualities of the glass, and specifically, solar glass will typically be formulated to reduce or eliminate the transmission of undesirable wavelengths of radiation, such as near infrared and ultraviolet. Solar glass can also be tinted, which results in, for some applications, a desirable reduction of transmission of visible light. Examples of solar glass that are useful in the present invention are bronze glass, gray glass, low E (low emissivity) glass, and solar glass panels as are known in the art, including those disclosed in U.S. Pat. Nos. 6,737,159 and 6,620,872.

In addition to the embodiments given above, other embodiments comprise a rigid glazing substrate other than glass. In these embodiments, the rigid substrate can comprise acrylic such as Plexiglas®, polycarbonate such as Lexan®, and other plastics that are conventionally used as glazings.

### Polymer Film

The polymer film can be any suitable thermoplastic film that is used in glazing film manufacture. In various embodiments, the thermoplastic film can comprise polycarbonates, acrylics, nylons, polyesters, polyurethanes, polyolefins such as polypropylene, cellulose acetates and triacetates, vinyl acetals, such as poly(vinyl butyral), vinyl chloride polymers and copolymers and the like, or another plastic suitable for use in a performance film.

In various embodiments, the polymer film is a polyester film, for example poly(ethylene terephthalate). In various embodiments the polymer film can have a thickness of 0.012 millimeters to 0.40 millimeters, preferably 0.01 millimeters to 0.3 millimeters, or 0.02 to 0.025 millimeters. The polymer film can include, where appropriate, a primer layer to facilitate bonding of the non-stoichiometric aluminum oxide layer to the polymeric substrate, to provide strength to the substrate, and/or to improve the planarity.

The polymer films are optically transparent (i.e. objects adjacent one side of the layer can be comfortably seen by the eye of a particular observer looking through the layer from the other side). In various embodiments, the glazing film substrate comprises materials such as re-stretched thermoplastic films having the noted properties, which include polyesters. In various embodiments, poly(ethylene terephthalate) is used, and, in various embodiments, the poly(ethylene terephthalate) has been biaxially stretched to improve strength, and has been heat stabilized to provide low shrinkage characteristics when subjected to elevated temperatures (e.g. less than 2% shrinkage in both directions after 30 minutes at 150° C.).

Various coating and surface treatment techniques for poly(ethylene terephthalate) film that can be used with the present invention are disclosed in published European Application No. 0157030. Films of the present invention can also include an antifog layer, as are known in the art.

Useful example of polymer films that can be used with the present invention include those described in U.S. Pat. Nos. 6,049,419 and 6,451,414, and U.S. Pat. Nos. 6,830,713, 6,827,886, 6,808,658, 6,783,349, and 6,569,515.

In various embodiments of the present invention, a polymer film includes a primer layer that promotes adhesion of the non-stoichiometric aluminum oxide layer to the polymeric material.

In various embodiments of the present invention, a polymer film is dyed to impart color. The added non-stoichiometric aluminum oxide layer, which can alter the color balance of the transmitted visible spectrum, optically combines with the dye in the film to produce a final coloration that is dependent on both the choice of dye and the properties of the aluminum oxide layer. Dyed polymer films are available, for example and without limitation, from CPFilms (Martinsville, Va.) in visible transmission ranges of 2 to 90%.

### Hardcoats

In various embodiments, polymer films of the present invention comprise a hardcoat. A hardcoat can be formed over the layer of non-stoichiometric aluminum oxide to protect that layer from mechanical damage or deterioration caused by exposure to the environment.

Any suitable, conventional hardcoat can be used as a scratch resistant layer on a polymer film of the present invention. In particular, the hardcoats may be a combination of poly(silicic acid) and copolymers of fluorinated monomers, with compounds containing primary alcohols (as described in U.S. Pat. No. 3,429,845), or with compounds containing primary or secondary alcohols (as described in U.S. Pat. No. 3,429,846). Other abrasion resistant coating materials suitable for the purpose are described in U.S. Pat. Nos. 3,390,203; 3,514,425; and, 3,546,318.

Further examples of useful hardcoats include cured products resulting from heat or plasma treatment of a hydrolysis and condensation product of methyltriethoxysilane.

Hardcoats that are useful also include acrylate functional groups, such as a polyester, polyether, acrylic, epoxy, urethane, alkyd, spiroacetal, polybutadiene or polythiol polyene resin having a relatively low molecular weight; a (meth)acrylate oligomer or prepolymer of a polyfunctional compound such as a polyhydric alcohol; or a resin containing, as a reactive diluent, a relatively large amount of a monofunctional monomer such as ethyl (meth)acrylate, ethylhexyl (meth)acrylate, styrene, methylstyrene or N-vinylpyrrolidone, or a polyfunctional monomer such as trimethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate or neopentyl glycol di(meth)acrylate.

In various embodiments, acrylate hard coats are preferred, and particularly urethane acrylates.

Polymer films of the present invention can be incorporated into and onto glass and other glazing materials in any suitable manner. In various embodiments, one or more adhesive layers (mounting or laminating), polymer films, and/or hardcoat layers can be applied to a glazing panel. Examples of glazings incorporating a polymer film of the present invention include, without limitation, the following constructs, where each film can be dyed or comprise ultraviolet absorbers, where “NSAO” is a layer of non-stoichiometric aluminum oxide, “film” is a polymer film, and where (NSAO/film) and (film/NSAO) represent glazing films of the present invention:

Glass/adhesive/film/adhesive/(NSAO/film)/hardcoat

Glass/adhesive/film/adhesive/(film/NSAO)/hardcoat

Glass/adhesive/film/adhesive/(NSAO/film)/adhesive/film/hardcoat

Glass/adhesive/film/adhesive/(film/NSAO)/adhesive/film/hardcoat

Glass/adhesive/(NSAO/film)/hardcoat

Glass/adhesive/(film/NSAO)/hardcoat

The present invention includes glazings having a solar control film of the present invention disposed on a surface. In various embodiments, a glass layer, such as a window or a windshield, has a solar control film of the present invention adhered on its surface to form a composite glass of the present invention.

The present invention includes safety bilayer glass panels, which are generally constructed with the following layer organization: glass layer//polymer sheet//polymer film. In these bilayer glass panels, the polymer sheet can be any suitable thermoplastic material, and, in various embodiments, the polymer sheet comprises plasticized poly(vinyl butyral)(PVB). In this bilayer embodiment, the glazing film can be any of the polymer films described herein comprising a layer of non-stoichiometric aluminum oxide. The bilayer can be formed using any conventional technique, including using a second, temporary pane of glass disposed in contact with the functional coating to allow for lamination of the bilayer, with subsequent removal of the temporary pane of glass after the lamination process bonds the other layers together into the bilayer.

### EXAMPLES

### Example 1

A layer of non-stoichiometric aluminum oxide is sputtered onto a poly(ethylene terephthalate) film (Lumirror® U50 film from Toray Plastics (America), Inc. or HOSTAPHAN® 7333 film from Mitsubishi Polyester Films). Various electromagnetic signals are then produced on one side of the film, and the attenuation caused by the film is measured. A Rohde and Schwarz signal generator model SML03 is used to produce the radio frequencies (RF) and a 10 dB signal strength used for testing. The signal generator can produce signals from 9 kHz to 3.3 GHz. The RF frequencies are received by an Advantest model R3131A spectrum analyzer. The spectrum analyzer can analyze signals from 9 kHz to 3 GHz. Cables from the signal generator and spectrum analyzer are connected to a brass housing.

A sample film is modified to form a hole through which RF signals can be propagated unimpeded, and that film is placed in the brass housing. A base dB signal strength at each frequency to be tested is established. Next, a complete sample of the film to be tested is placed in the brass housing and the dB signal strength is recorded. The final dB recordings are subtracted from the base dB recording, which results in the attenuation of the sample film at the designated frequencies. Results are shown in Table 1:

TABLE 1

| | Frequency | Film with Hole | Complete Film | Attenuation |
|---|---|---|---|---|
| Signal Type | (MHz) | (dB) | (dB) | (dB) |
| AM | 0.6 | −11.17 | −11.94 | −0.77 |
| AM | 0.9 | −7.44 | −8.17 | −0.73 |
| AM | 1.4 | −2.31 | −3.14 | −0.83 |
| FM | 90 | 8.61 | 8.5 | −0.11 |
| FM | 100 | 8.61 | 8.64 | 0.03 |
| Cell | 869.04 | 7.92 | 7.89 | −0.03 |
| Cell | 893.87 | 7.72 | 7.67 | −0.05 |
| Cell | 824.04 | 7.81 | 7.81 | 0 |
| Cell | 848.97 | 7.86 | 7.86 | 0 |
| GPS | 1575.42 | 6.86 | 6.78 | −0.08 |
| Tire Pressure | 0.49 | −11.03 | −11.08 | −0.05 |
| Tire Pressure | 0.5 | −10.81 | −10.86 | −0.05 |
| Tire Pressure | 0.51 | −10.58 | −10.64 | −0.06 |
| Tire Pressure | 315 | 9.25 | 9.22 | −0.03 |
| Tire Pressure | 345 | 9.17 | 9.14 | −0.03 |
| Tire Pressure | 434 | 9.08 | 9.08 | 0 |
| Tire Pressure | 868 | 8.67 | 8.67 | 0 |
| Tire Pressure | 915 | 8.75 | 8.75 | 0 |
| Tire Pressure | 433.92 | 9.08 | 9.06 | −0.02 |
| Tire Pressure | 13.56 | 8.72 | 8.72 | 0 |

### Example 2

A layer of non-stoichiometric aluminum oxide is sputtered onto each of five poly(ethylene terephthalate) films (Lumirror® U50 film from Toray Plastics (America), Inc. or HOSTAPHAN® 7333 film from Mitsubishi Polyester Films). Various optical properties are measured using a Cary UV, visible, and NIR spectrometer model 5000. Summer conditions are: indoor temperature 23.9° C. (75° F.); outdoor temperature 31.7° C. (89° F.); and, solar intensity of 0.28 (kJ/hour)/cm² (248 (BTU/hr)/sq ft). Winter conditions are: indoor temperature 20° C. (68° F.); outdoor temperature −7.78° C. (18° F.); and, solar intensity of 0 (kJ/hour)/cm² (0 (BTU/hr)/sq ft.) Winter median conditions are: indoor temperature 20° C. (68° F.); outdoor temperature 7.22° C. (45° F.); and, solar intensity of 0 (kJ/hour)/cm² (0 (BTU/hr)/sq ft.). Results are shown in Table 2.

TABLE 2

| | | | | | |
|---|---|---|---|---|---|
| Characteristic | Film 1 | Film 2 | Film 3 | Film 4 | Film 5 |

General Calculations

| | | | | | |
|---|---|---|---|---|---|
| Solar Transmission (%) | 29.71 | 32.87 | 43.41 | 46.76 | 48.01 |
| Solar Reflectance (%) | 8.11 | 8.39 | 8.22 | 9.72 | 11.68 |
| Solar Absorbance (%) | 62.18 | 58.74 | 48.37 | 43.52 | 40.31 |
| Visible Light | 4.64 | 12.83 | 30.42 | 37.19 | 43.05 |
| Transmission (%) | | | | | |
| Visible Light | 6.47 | 6.48 | 7.45 | 9.65 | 12.76 |
| Reflectance (%) | | | | | |
| Ultraviolet Light | 0.02 | 0.09 | 0.14 | 0.16 | 0.15 |
| Transmission (%) | | | | | |

Summer Calculations

| | | | | | |
|---|---|---|---|---|---|
| Solar Heat Gain | 0.46 | 0.49 | 0.56 | 0.58 | 0.59 |
| Coefficient | | | | | |
| U Factor | 1.05 | 1.06 | 1.05 | 1.05 | 1.05 |
| Shading Coefficient | 0.53 | 0.56 | 0.65 | 0.67 | 0.68 |
| Total Solar Energy | 53.66 | 51.34 | 43.66 | 41.60 | 41.21 |
| Rejection (%) | | | | | |

Winter Calculations

| | | | | | |
|---|---|---|---|---|---|
| U Factor | 1.14 | 1.15 | 1.14 | 1.14 | 1.14 |

Winter Median Calculations

| | | | | | |
|---|---|---|---|---|---|
| U Factor | 1.10 | 1.10 | 1.10 | 1.10 | 1.10 |

### Example 3

A layer of non-stoichiometric aluminum oxide is sputtered onto a first poly(ethylene terephthalate) film (Lumirror® U50 film from Toray Plastics (America), Inc. or HOSTAPHAN® 7333 film from Mitsubishi Polyester Films), which is dyed. A layer of aluminum is sputtered onto a second poly(ethylene terephthalate) film, which is dyed, and the resulting film (available as ATR35CH from CPFilms) has about 35% visible light transmission 200 ohms per square surface resistivity.

The two films are then tested as in Example 1. Results are shown in Table 3:

TABLE 3

| | | | | Film 2 - Non-Stoichiometric | | |
|---|---|---|---|---|---|---|
| | Film 1 - Aluminum Layer | | | Aluminum Oxide Layer | | |
| | Film | | | Film | | |
| | With | Complete | Attenu- | With | Complete | Attenu- |
| Frequency | Hole | Film | ation | Hole | Film | ation |
| (MHz) | (dB) | (dB) | (dB) | (dB) | (dB) | (dB) |
| 0.49 | −11.25 | −24.11 | −12.86 | −11.03 | −11.08 | −0.05 |
| 0.5 | −11.06 | −23.92 | −12.86 | −10.81 | −10.86 | −0.05 |
| 0.51 | −10.92 | −23.64 | −12.72 | −10.58 | −10.64 | −0.06 |
| 315 | 9.22 | 4.31 | −4.91 | 9.25 | 9.22 | −0.03 |
| 345 | 9.14 | 3.72 | −5.42 | 9.17 | 9.14 | −0.03 |
| 434 | 9.08 | 3 | −6.08 | 9.08 | 9.08 | 0 |
| 868 | 8.67 | 3.61 | −5.06 | 8.67 | 8.67 | 0 |
| 915 | 8.75 | 4.28 | −4.47 | 8.75 | 8.75 | 0 |
| 433.92 | 9.08 | 3 | −6.08 | 9.08 | 9.06 | −0.02 |
| 13.56 | 8.86 | 3.89 | −4.97 | 8.72 | 8.72 | 0 |

### Example 4

A layer of non-stoichiometric aluminum oxide is sputtered onto a first poly(ethylene terephthalate) film (Lumirror® U50 film from Toray Plastics (America), Inc. or HOSTAPHAN® 7333 film from Mitsubishi Polyester Films) to form a layer having a surface resistivity of 2,500 Ohms per square. A layer of aluminum is sputtered onto a second poly(ethylene terephthalate) film, which is dyed, and the resulting film (available as ATR35CH from CPFilms) has about 35% visible light transmission 200 ohms per square surface resistivity. A layer of a commercially available film having a “ceramic” type coating on a poly(ethylene terephthalate) film is provided. A fourth film is provided with no coating (Lumirror® U50 film from Toray Plastics (America), Inc. or HOSTAPHAN® 7333 film from Mitsubishi Polyester Films).

A Knight RF generator (Allied Radio, Chicago) is used to produce a 900 kHz signal at −35.3 dbV. A 123 Scopemeter (available from Fluke Incorporated, Everett, Wash.) is used to detect frequency and dbV across each of the films. Results are shown in Table 4, below.

TABLE 4

| | Frequency | dbV | |
|---|---|---|---|
| Layer Type | Measured | Measured | dbV drop |
| No Layer | 900 Khz | −35.3 | 0 |
| Aluminum | Distorted | −44.8 | 9.5 |
| Ceramic | Distorted | −43.8 | 8.5 |
| Coating | | | |
| Non- | 900 Khz | −34.7 | −0.6 |
| stoichiometric | | | |
| Aluminum | | | |
| Oxide | | | |

### Example 5

Three 30.48 centimeter (1 foot) square glass panes are filmed with one of three layers of polymer film having either a ceramic layer, a metallized layer, or a non-stoichiometric layer of aluminum oxide, as provided in Example 4. Each filmed glass pane is then held over a hand-held global positioning sensor, and signal strength is observed. A significant decline is signal strength is noted for the ceramic and metallized filmed, and little or no signal drop off is seen with the non-stoichiometric aluminum oxide layered film.

Although embodiments of the present invention have been described herein, it will be clear to those of ordinary skill in the art that many other permutations are possible and are within the scope and spirit of the present invention. In addition, many modifications may be made to adapt a particular situation or material to the teachings of the invention without departing from the essential scope thereof. Therefore, it is intended that the invention not be limited to the particular embodiments disclosed herein for carrying out this invention, but that the invention will include all embodiments falling within the scope of the appended claims.

It will further be understood that any of the ranges, values, or characteristics given for any single component of the present invention can be used interchangeably with any ranges, values, or characteristics given for any of the other components of the invention, where compatible, to form an embodiment having defined values for each of the components, as given herein throughout.

Any figure reference numbers given within the abstract or any claims are for illustrative purposes only and should not be construed to limit the claimed invention to any one particular embodiment shown in any figure.

Unless otherwise noted, drawings are not drawn to scale.

Each reference, including journal articles, patents, applications, and books, referred to herein is hereby incorporated by reference in its entirety.

We claim:

1. A glazing film, comprising, in order:
a polymer film;
an optional primer layer;
an optional layer of metal or metal alloy;
a layer of non-stoichiometric aluminum oxide.

2. The glazing film of claim 1, wherein said layer of non-stoichiometric aluminum oxide has a surface resistivity of greater than 1,000 ohms per square.

3. The glazing film of claim 1, wherein said layer of non-stoichiometric aluminum oxide has an oxygen to aluminum atomic ratio of less than 3 to 2.

4. The glazing film of claim 1, wherein said layer of non-stoichiometric aluminum oxide has an oxygen to aluminum atomic ratio of less than 2.55 to 2.

5. The glazing film of claim 1, wherein said layer of non-stoichiometric aluminum oxide has a thickness of 3.5 to 50 nanometers.

6. The glazing film of claim 1, wherein said layer of non-stoichiometric aluminum oxide has a thickness of 3.5 to 40 nanometers.

7. The glazing film of claim 1, wherein said layer of non-stoichiometric aluminum oxide has the following optical transmission properties: solar transmission 45 to 55%, visible light transmission 45 to 55%, ultraviolet transmission 25 to 45%, and infrared transmission 55 to 85%.

8. The glazing film of claim 1, wherein said layer of metal or metal alloy comprises nickel or nickel alloy.

9. The glazing film of claim 8, wherein said nickel or nickel alloy layer has a thickness of 0.50 to 5.0 nanometers.

10. The glazing film of claim 9, wherein said nickel or nickel alloy layer comprises the following elements, with each element given as a maximum percent by weight: C 0.004, Fe 5.31, Mo 15.42, Mn 0.48, Co 1.70, Cr 15.40, Si 0.02, S 0.004, P 0.005, W 3.39, V 0.16, and the balance Ni.

11. A glass composite comprising,
a layer of glass, and
a glazing film disposed on said layer of glass, wherein said glazing film comprises, in order:
a polymer film;
an optional primer layer;
an optional layer of metal or metal alloy;
a layer of non-stoichiometric aluminum oxide.

12. The glass composite of claim 11, wherein said layer of non-stoichiometric aluminum oxide has an oxygen to aluminum atomic ratio of less than 3 to 2.

13. The glass composite of claim 11, wherein said layer of non-stoichiometric aluminum oxide has an oxygen to aluminum atomic ratio of less than 2.55 to 2.

14. The glass composite of claim 11, wherein said layer of non-stoichiometric aluminum oxide has a thickness of 3.5 to 50 nanometers.

15. The glass composite of claim 11, wherein said layer of non-stoichiometric aluminum oxide has a thickness of 3.5 to 40 nanometers.

16. The glass composite of claim 11, wherein said non-stoichiometric aluminum oxide layer has the following optical transmission properties: solar transmission 45 to 55%, visible light transmission 45 to 55%, ultraviolet transmission 25 to 45%, and infrared transmission 55 to 85%.

17. The glass composite of claim 11, wherein said layer of metal or metal alloy comprises nickel or nickel alloy.

18. The glazing film of claim 17, wherein said nickel or nickel alloy layer has a thickness of 0.50 to 5.0 nanometers.

19. The glass composite of claim 18, wherein said nickel or nickel alloy layer comprises the following elements, with each element given as a maximum percent by weight: C 0.004, Fe 5.31, Mo 15.42, Mn 0.48, Co 1.70, Cr 15.40, Si 0.02, S 0.004, P 0.005, W 3.39, V 0.16, and the balance Ni.

20. The glass composite of claim 11, wherein said layer of non-stoichiometric aluminum oxide has a surface resistivity of greater than 1,000 ohms per square.
